(19) United States
(12) Patent Application Publication
(10) Pub. No.: US 2010/0173719 A1
(43) Pub. Date: Jul. 8, 2010

(54) System and Method of Graphical Representation of the Bowling Game Score

(75) Inventor: Roberto Simeone, Botticino Sera (Brescia) (IT)

Correspondence Address: SHOEMAKER AND MATTARE, LTD, 10 POST OFFICE ROAD - SUITE 100, SILVER SPRING, MD, 20910, US

(73) Assignee: STELTRONIC S.P.A., Botticino Sera (Brescia) (IT)

(21) Appl. No.: 12/666,526

(22) PCT Filed: Jun. 28, 2007
(86) PCT No.: PCT/IT07/00463

§ 371 Date: Dec. 23, 2009

(51) Int. Cl. A63D 5/04; G06T 15/00

(52) U.S. Cl. 473/70; 345/419

(57) ABSTRACT

The invention relates to a system and method of representation of the bowling game score. The system comprises means for detecting an external event associated to a game step and processing means suitable for receiving information relating to said external event and processing it to be represented on a monitor (14), said processing means being suitable for representing said information in three-dimensional format. The system further comprises means for generating auxiliary animated images in superimposition to the information regarding the generated event, for example interacting with the representation of the information relating to the generated event.

### FIELD OF THE INVENTION

The present invention relates to systems for the automatic detection of the bowling game score and, in particular, it relates to a system and method of graphical representation of the score.

### BACKGROUND OF THE INVENTION

Computer systems have long been known that detect the score obtained by a player with the throw and display it on a display located in the proximity of the lane or on a different support, automatically calculating the score obtained.

At present, all the systems combine the more or less detailed graphical representation of the score, the capability of representing animated scenes or clips, in superimposition or as an alternative to the gaming grid, which have the purpose of attracting the players' attention, of making the event more pleasant, of representing advertisement information or of other type usually relating but also not necessarily related to the game itself.

In all the cases, the animated scenes or clips currently used consist of two-dimensional graphical representations that are read and displayed at the suitable time, but that are not created in real time according to the performance of the game and that therefore are not capable of interacting in real time with the game grid. In other words, they are substantially clips that try to simulate three-dimensional representations.

The object of the present invention is, on the other hand, to propose a method and system of graphical representation of the bowling game score capable of overcoming the limits of the representation methods mentioned hereinbefore.

Said object is obtained with a method of representation according to claim 1 and system of representation of the bowling game score according to claim 17.

### BRIEF DESCRIPTION OF THE DRAWINGS

The features and advantages of the system and method of representation according to the invention will in any case appear more clearly from the following description of some preferred embodiments, displayed as an indicative non-limiting example, wherein:

FIG. 1 shows a schematic view of the devices associated to the system of representation of the bowling score according to the invention;

FIG. 2 shows a block diagram of the three-dimensional objects involved in the representation;

FIG. 3 shows a flow chart of the main graphical steps that can be graphically represented with the method of representation according to the invention;

FIG. 4 shows a flow chart of the score acquisition process;

FIG. 5 shows a flow chart of the program relating to the “ball throw” event;

FIG. 6 shows a flow chart of the program executed by the 3D graphical engine;

FIG. 7 shows a diagram of the structure of the “game sheet” three-dimensional object;

FIG. 8 shows a flow chart of the program that generates a movement of an object;

FIG. 9 shows a flow chart of the program implemented by the 3D graphical engine for performing the movement;

FIG. 10 shows a display example of the crossing of game sheets with movement of the game sheets from one monitor to another;

FIG. 11 shows an example of three-dimensional animation of a representation of a score;

FIG. 12 shows an example of three-dimensional representation of a “sparemaker” throw; and

FIG. 13 shows an example of movement of a game grid.

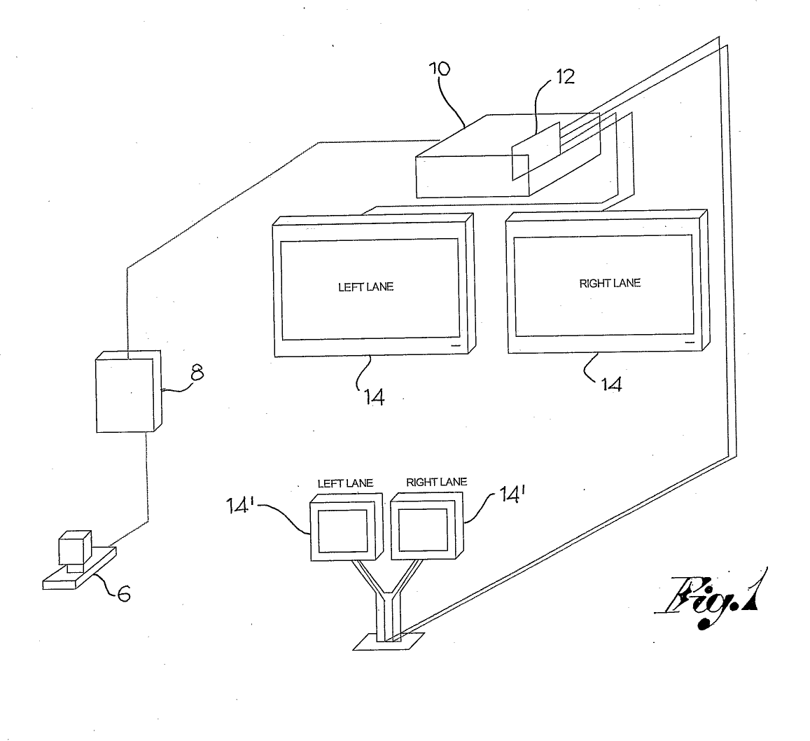

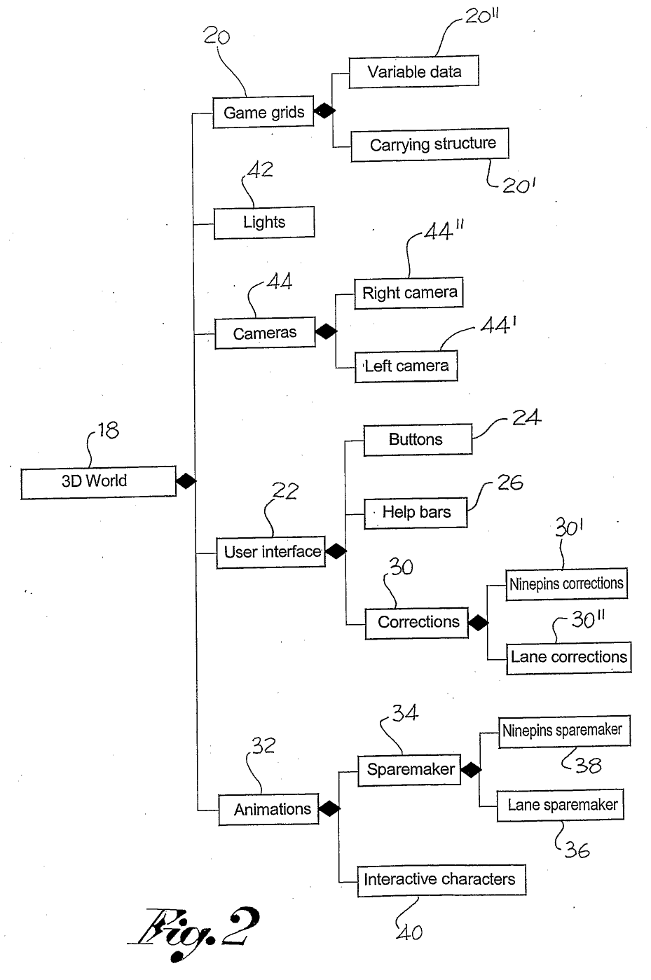

### DETAILED DESCRIPTION OF THE INVENTION

In accordance with a general embodiment, the system of representation of the bowling game score according to the invention comprises means for detecting an external event associated to a game step (for example, the throw of a ball, a command from the central computer (“front desk”), the input of data from the bowler console, and processing means suitable for receiving information relating to said external event and processing it to be represented on a monitor, said processing means being suitable for representing said information in three-dimensional format.

In accordance with a preferred embodiment, the representation system further comprises means for generating auxiliary animated images in superimposition to the information regarding the generated event.

According to a preferred embodiment, said animated images interact with the representation of the information regarding the generated event.

In accordance with an example of accomplishment, the means for detecting an external event comprise a detecting device 6 suitable for detecting the status of the ninepins after a throw and a pinsetter interface 8 suitable for receiving the information from the detecting device and sending it to the display means. The detecting device 6 and the pinsetter interface 8 can also be integrated in a single device.

The processing means comprise a central computer 10 provided with a high performance graphical card 12, that is, having such computation power as to allow both the three-dimensional representation of objects and an animation thereof. For example, the graphical card has a gpu (graphic processor unit) capable of reproducing 3D objects with the Microsoft DirectX 9.0 technology. In accordance with a preferred embodiment, each card is capable of piloting a pair of high monitors 14, that is, arranged on two lanes, and a pair of low monitors 14′, that is, associated to the bowler console. Advantageously, each system is capable of mounting at least two graphical cards at the same time and, therefore, of representing the score for four bowling lanes.

The computer 10 is suitable for running an lane score management program based on the extensive use of the 3D graphics that, for example, is based on Microsoft DirectX technology.

The management program is capable of creating and moving a series of three-dimensional objects in real time. A graphical engine 16 associated to the graphical card is intended for the representation of such objects on the monitors 14, 14′. In other words, all the graphical elements on the lanes, both game grids and animations, correspond to ‘views’ of 3D objects created and moved in real time by the program itself.

Going in further detail, in accordance with a preferred embodiment of the invention, the elements that make up the scene displayed on the lane monitors are as follows.

1) the “3D World” 18: this is the set of all the three-dimensional objects (3D) created by the program. These objects include all the game grids 20, all the user interface items 22 (buttons 24, help bars 26, corrections 30 of the ninepins 30′ and of lane 30″, panels for writing the bowler's names, etc. . . . ), all the elements of animations 32 (sparemaker 34 with relevant lane 36 and ninepins 38, interactive characters 40, etc.). As will be better explained hereinafter, the 3D objects are organised in a hierarchic manner (that is, each object can contain sub-objects) and can consist of fixed parts, read from files, and of parts generated in real time by the program. In particular, for the game grids 20 all the ‘carrying’ structure 20′ is read from file, whereas the scores, the totals and other variable data 20″, such as the bowler's names, handicaps and others, are generated in real time as they are not known in advance. In accordance with a preferred embodiment, all the 3D fixed parts 20′ are mesh coded according to the Microsoft “.X” format, whereas all the variable data 20″ (names, totals, etc.) are created in real time as mesh by the program.

2) Lights 42: they define the scene lighting. Preferably, the light is of the directional/mirror type and allows obtaining realistic light-and-shade and brightness effects.

3) Cameras 44: they define the current position of the observer as in a normal film shot. There are usually two, one for the left side 44′ and one for the right side 44″. Each camera is defined by the position, orientation and aperture of the lens. The stand-by positions and shots are centred relative to the relevant game sheets. They are called stand-by positions because during the animations or particular gaming steps, they can move and rotate to obtain the optimum shooting or zoom effects. For example, during the Sparemaker animation, the camera moves forward for following the bowl motion towards the ninepin castle from nearby.

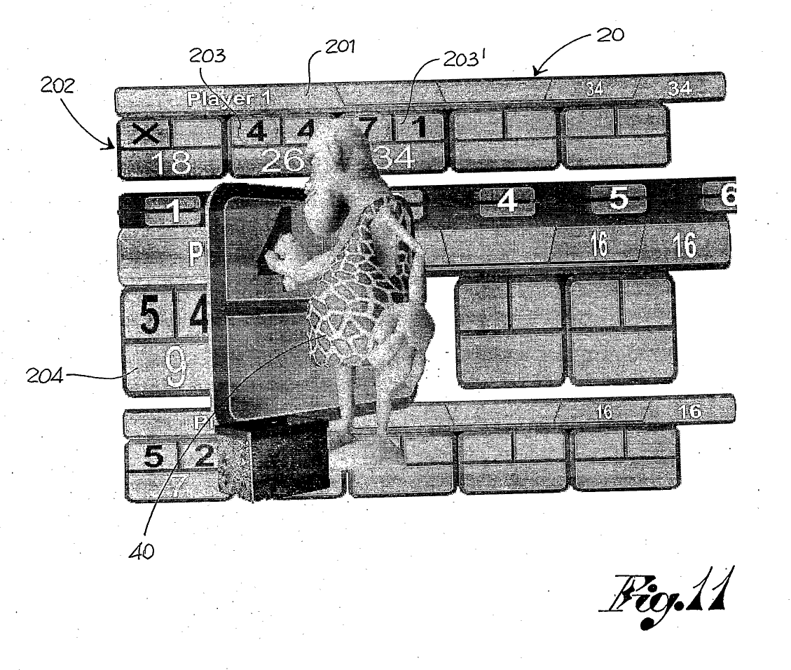

4) Movement: the 3D World 18 and cameras 44 are free to move wherever in the scene in order to create the desired effects. In particular, there is a ‘normal’ position of the game grids and of the ‘cameras’ corresponding to a static score presentation. For example, in order to display an object on the left or right monitor it is sufficient to move it in the 3D world so that it enters in the view field of the left or right camera. This allows obtaining the special effect of making graphical objects move from one monitor to the other as if it were a single screen (function used for the ‘crossed’ game mode) (FIG. 10). The movement of composite 3D objects follows the hierarchy of the objects themselves: each sub-object is moved relative to the ‘father’ object in the hierarchy: very complex movements are thus obtained starting from a set of simpler movements. Another type of movement is that typical of animations (shinned mesh) that is all or partly coded in a file. The main object of this type of movement is to move 3D characters in a realistic manner and make them interact with the grids in predetermined game steps.

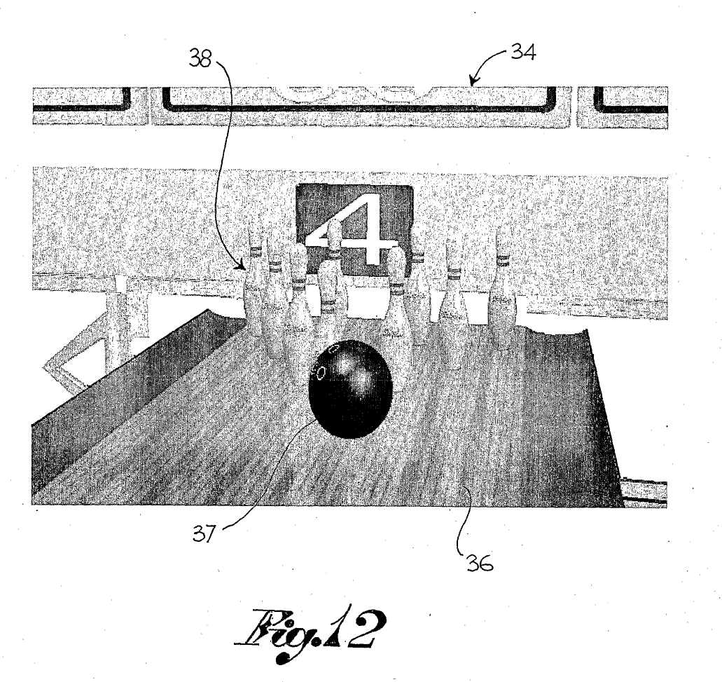

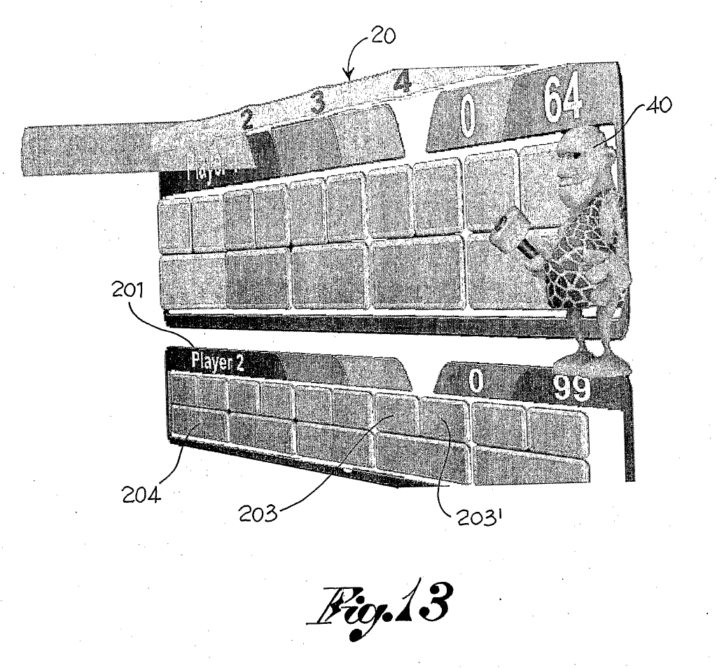

Going back now to the description of the 3D world, and with reference for example to FIG. 11, the main graphical objects present in the program are as follows.
Game sheet 20: this is the root of the hierarchy of 3D objects that represent the score. In accordance with an embodiment, each game sheet contains one to n bowlers, each represented by a ‘bowler stripe’ or grid 201. In turn each bowler stripe contains various sub-parts, for example the area for the bowler identification (name), detected bowl speed, any points deducted and total game points, and the ten game frames 202. In turn, each frame contains other 3D objects for throws 203, 203′ (for example first and second throw, respectively) and the total frames 204, or game partial result. Each of these sub-parts can move, rotate or become freely deformed relative to all the others.
User interface 22: this is the set of 3D objects (panels and ninepin surface) for setting the names and other data from the bowler console. A turning bar 26 containing a context-dependent help wording is always created together with the data input panels.
Sparemaker 34: this is a complex graphical animation that is intended for telling the bowler how to make the second throw for hitting the ninepins left standing with the first one (FIG. 12). The 3D objects involved are bowling lane 36, bowl 37 and the ninepin castle 38, in real proportions. The program makes a ‘virtual throw’ wherein the bowl rolls on the lane making the right trajectory and hitting in the end the ninepins in the exact position that allows knocking them all down. Also the camera follows the throw close up to make the scene more realistic.
Animated character 40: this is a virtual man that moves interacting with the game grid for creating illustrations based on the throw just made (FIG. 11).

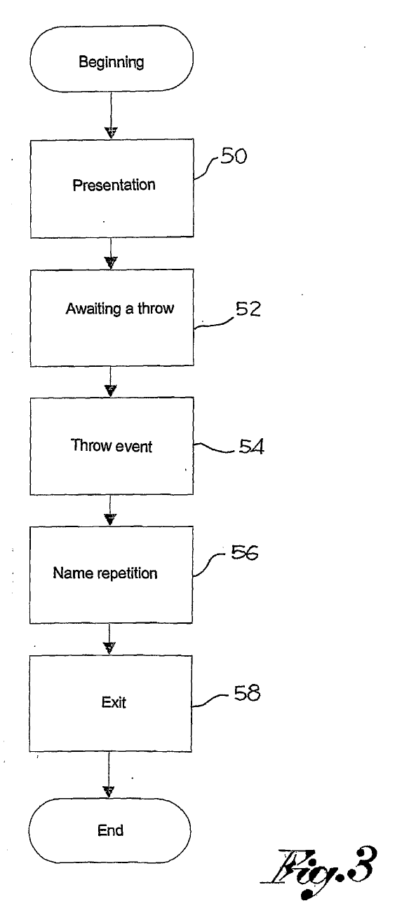

In accordance with a preferred embodiment, the three-dimensional representation of the information on the monitors relates to different game steps, not just the representation of the actual score. In particular, the game steps that can be graphically represented can be the following (FIG. 3):
Presentation 50: this is the step of entry of the game grids, which corresponds to the lane opening by the front desk or bowler console. The game sheet is created with the initial data and without scores, and it enters with a movement towards the camera to represent the arrival of the players on the lane.
Awaiting a throw 52: the stripe of the selected bowler becomes larger, for example becoming deformed in vertical direction, and a cursor moves and places itself on the name to indicate the wait for the throw.
Throw 54: the score relating to the throw just made is immediately represented on the grid. Optionally, an animation selected from sparemaker, animated character and 2D clip is started. After a delay and after the end of the optional animation, it is possible to move to the next bowler, if necessary. For example, this occurs by enlarging the new bowler and reducing the current one through continuous 3D deformations in vertical direction. The cursor moves continuously shifting vertically on the name of the new current bowler.
Name repetition 56: when a game sheet is complete, upon the arrival of a new throw the entire sheet makes a full turn rotating on the vertical axis thereof (FIG. 13) and at the end of the rotation all the scores are deleted to make room for a new game.
Exit 58: this is the step of exit of the game grids, which corresponds to the lane closing by the front desk. The game sheet moves away from the camera before it is destroyed to represent the bowlers' leaving of the lane.

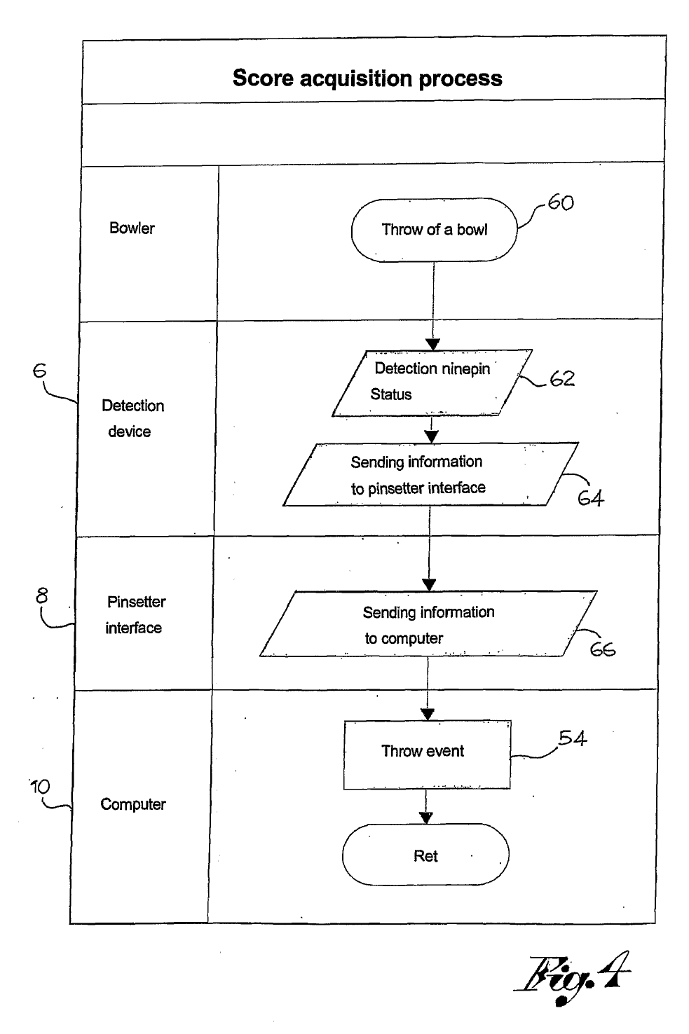

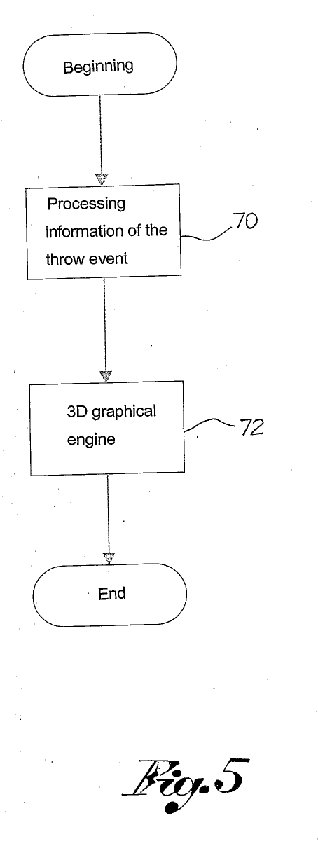

In particular, in accordance with a preferred embodiment, the score acquisition and display process comprises the following steps (FIGS. 4 and 5):
a bowler makes a throw (step 60);
the detecting device 6 reads the ninepin status (step 62) and sends the relevant information to the pinsetter interface 8 (step 64);
the pinsetter interface sends the information received to computer 10 in the suitable format (step 66);
the computer starts the program for processing the data received (step 70); and
the 3D graphical engine 16 is activated for displaying the information generated by the program on monitors 14 (step 72).

The operation of the processing program and of the 3D graphical engine will now be described.

The processing program allows creating, moving and destroying the 3D meshes used for representing the scene and making it evolve.

Any important external event, such as the throw of a bowl, a command from front desk, the input of data from the bowler console and others, updates the status of all 3D objects present (i.e. its geometrical representation by mesh) and programs the movement thereof. In particular, the objects can be created, destroyed or made temporarily invisible. As regards the geometry, they can be decreased, rotated and shifted freely in the 3D space through the calculation and the application of specific “transformation matrices”. The movement is implemented through transformation matrix lists, which are applied individually to every frame (every 1/60 s) and are in substance the scene frames.

In practice, all the graphical objects used in the program are 3D meshes characterised by a geometry, one or more materials and in some cases one or more textures. These objects may be classified in three different types, according to the generation mechanism:
1) Objects created from “.X” files without animation;
2) Objects created from “.X” files with fixed animation (contained in the file itself);
3) Simple objects created in real time and that represent the game data (names, totals, etc.).

The objects of the first type, even if without intrinsic movement, can be moved and deformed in real time by the program; in general, also, since they are composite objects, it is also possible to move some parts thereof relative to others. The objects of the first type are mainly used for representing the game grids.

Moreover, it is possible to share some elements of objects without intrinsic animation with objects provided with intrinsic animation, so as to obtain interactive animations.

By interactive animation it is meant a ‘static’ animation (that is, entirely defined within the “.X” file thereof) that shares some elements with other 3D objects that depend on the current game step, normally parts of the game grids (called frame blocks). For example, the interactive animations are associated to the acquisition of a new throw. The complete sequence of the events that make an animation of this type is as follows:
Movement of the frame block relating to the shot just made from an initial position to a final position. During all this step the frame remains an exclusive part of the belonging grid. This movement may be a simple shifting or also contain a rotation. The throw just made will not yet be displayed on the block in question.
At the same time, the static animation that does not yet contain any part relating to the frame block, starts.
Upon the arrival to destination, the frame is picked up by the static animation, which manages it till the end thereof, displaying the throw just made.
The frame is returned to the grid, which manages the return movement to the initial position, normally a simple shifting with scale variation.

As mentioned above, the composite objects exhibit a hierarchic structure. In particular, each composite object is organised into a “tree” structure with nodes that branch off in a recursive manner into sub-nodes (children) up to reach the end “leaves”. Each portion of the overall object corresponds to a node with its sub-nodes, with the “root” node that represents the complete object. Moving a node relative to its ‘father node’ moves all the corresponding object portion thereof as if it were a stiff body; moving the “root node” moves the complete object like a single stiff body.

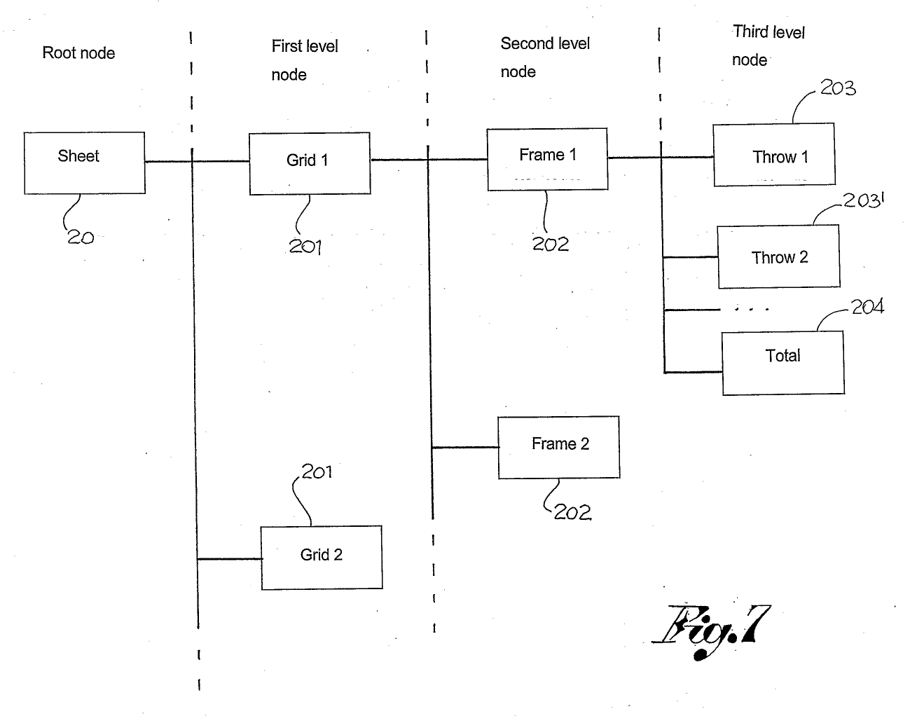

As a concrete example we may mention the game sheet that is organised according to the following hierarchy (FIG. 7).

The base or root is the game sheet 20; at the first level of sub-nodes there are the n grids 201 for the n bowlers; second level nodes branch off from each first level node that correspond to the various frame blocks 202; third level nodes branch off from each second level node that correspond to the ten throws 203, 203′ and to the total 204.

This structure allows making all the movements required for representing the progress of the score and all the related animations. For example, in order to cross the teams during a tournament it is possible to move all the sheet from one screen to the other; to make the game shift proceed it is possible to move only the grids relative to the sheet; to acquire a new throw it is sufficient to position the throw itself relative to the frame thereof; finally, to animate a frame block it is possible to move it relative to the grid it belongs to.

Going now into the details of the animation of the three-dimensional objects, it must be noted that the movement of a 3D object is a particular case of a more general ‘geometric transformation’ operation. From the mathematical standpoint, geometric transformations are represented by ‘transformation matrices’ and the objects by an interconnection of polygons (mesh) and thus by a set of points or vertices. In turn, each point is identified by a vector containing the coordinates x, y, z. Moving an object means changing the position of each point thereof and a simple system for moving a point is multiplying the vector that represents it by a matrix. Multiplying all the vectors relative to the points of an object by a same matrix equals to moving it or more in general, to ‘transforming’ it. It can be seen that by the suitable selection of a matrix, besides moving an object as if it were ad stiff body, it can also be rotated, enlarged, reduced or deformed in various ways. For example this is the method used for enlarging in vertical direction the scores of the selected bowler.

The method of the transformation matrices is also used in composite objects for defining the position of the various nodes relative to the parent nodes. To calculate the absolute position of a portion of a composite object (a node) it is sufficient to apply in a succession all the transformations (multiplying by the relative matrices) starting from the node itself up to arriving to the root.

Also the movement is obtained by handling the transformation matrices: at each frame, the matrices of the parts to be moved are recalculated so as to progressively move them from the initial to the final position.

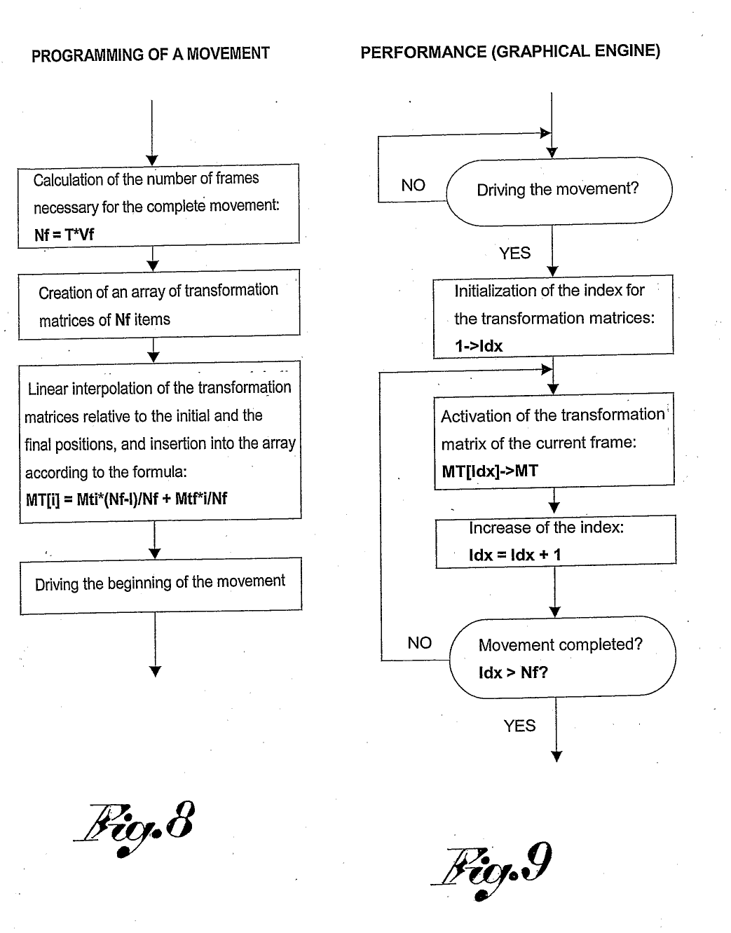

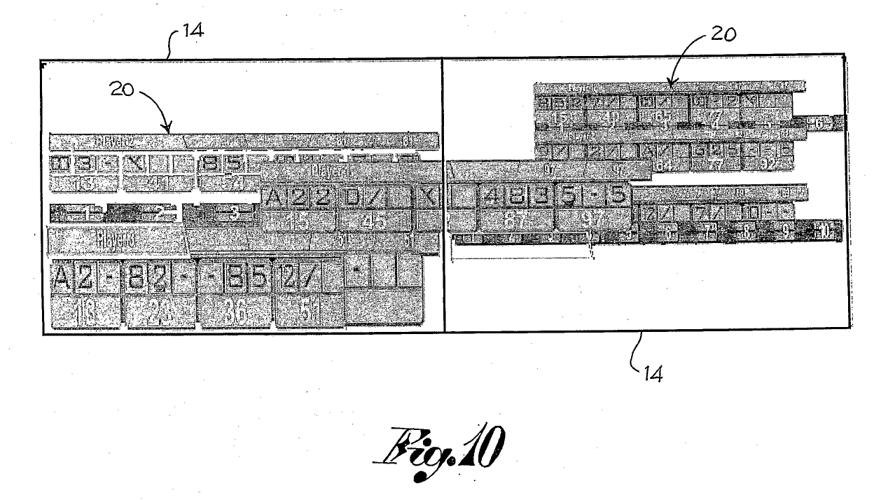

By way of an example, FIGS. 8 and 9 show the flow chart relating to the programming and execution of a simple movement of an object from an initial position (shifting+rotation+scale) to a final position by the 3D graphical engine. The variables used are:
MT: transformation matrix of the object in the current position (=initial)
MTf: transformation matrix of the object in the final position
MT[i]: transformation matrix of the index frame [i]
T: movement duration
Fv: frame frequency (Hz)
Nf: total number of frames for the movement.

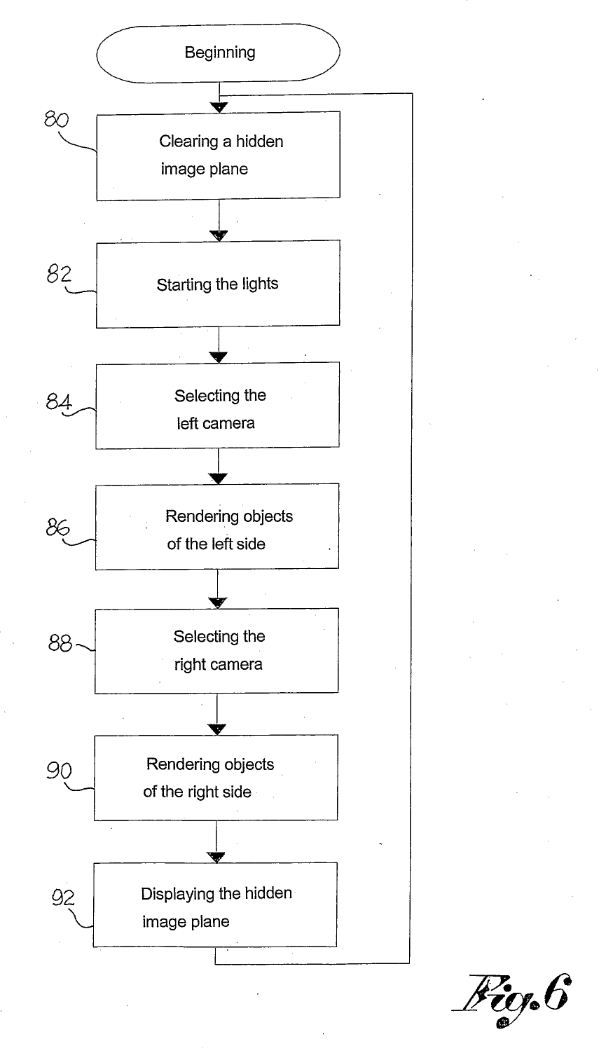

The 3D graphical engine is the part of program that allows creating and updating on the screen the image corresponding to the present 3D mode. In other words, the 3D graphical engine transforms the 3D virtual world, keeping into account the perspective, the light and the position of the cameras, in a 2D image on the screens. Technically, it is implemented through a program loop executed at the same frequency as the frame (60 Hz), wherein the following operations are executed in a sequence (FIG. 6):
Clearing 80 a hidden image plane;
Starting 82 the lights 42;
Selecting 84 the left Camera 44′;
Scanning and rendering 86 all the 3D objects present according to the camera view and the lights active on the hidden plane;
Selecting 88 the right Camera 44″;
Scanning and rendering 90 all the 3D objects present according to the camera view and the lights active on the hidden plane;
Actually presenting 92 the end result on the screen by displaying the hidden plane.

The hidden plane mechanism makes the scene visible only after all its elements have been drawn up, so as to ensure the highest quality of the image and the smoothness of the movements.

Using the score representation method according to the invention, each graphical object has own precise spatial location in the scene to be reproduced and it is therefore possible to make the grid containing the score interact with the various game events in the most varied manners.

The objects can move with high independence from each other and interact with characters that appear on the scene, not in superimposition or as an alternative to the game grids but rather having an active part in the evolution of the scene itself (they open the grid appearing from behind, break it up into pieces, make it explode, move it, etc.) modelling the appearance and the scenic dynamics thereof, creating very realistic effects with high scene impact that no current system can propose.

In other words, whereas the score representation methods currently known are not able to interact in real time with the score obtained, the method herein proposed is based on real 3D objects that are therefore able to represent a simulated reality of high realism and effect, and can therefore exploit the creative capabilities of the graphical team.

1-38. (canceled)

39. Method of representation of the bowling game score, comprising the steps of:
representing on at least one monitor of a processing unit at least a game sheet representing the game score by means of a plurality of three-dimensional objects having a geometrical representation by mesh;
detecting an external event associated to a game step,
sending information relating to said external event to said processing unit,
updating the game sheet according to said external event by means of application of at least a transformation matrix to at least one of said objects of the game sheet,
generating and representing on the monitor at least one three-dimensional object with static animation that shares at least one element with at least one three-dimensional object of the game sheet in such a way to obtain an interactive animation.

40. Method according to claim 39, wherein said external event is one of the events: a bowl throw, a command from central computer (“front desk”), the input of data from a bowler console.

41. Method according to any claim 39, wherein the three-dimensional objects are represented simulating lighting effects produced by a light source.

42. Method according to claim 39, wherein the three-dimensional objects are represented simulating a shooting effect by at least one camera.

43. Method according to claim 39, wherein each game sheet comprises a plurality of sub-parts carrying information relating to a bowler or a game step, each of said sub-parts being capable of moving, rotating or deforming irrespective of all the others.

44. A method according to claim 39, comprising the steps of:
reading the ninepin status by a detecting device;
sending the information detected to a computer programmed for generating images and/or animations in three-dimensional format associated to said information;
starting the program for processing the information received; and
activating a 3D graphical engine associated to the computer for displaying the three-dimensional images generated by the computer on at least one monitor.

45. Method according to claim 39, wherein each three-dimensional object is created, destroyed or made temporarily invisible.

46. Method according to claim 39, wherein each three-dimensional object of the game sheet can be decreased, rotated and shifted in the 3D space through the calculation and the application of the transformation matrices.

47. Method according to claim 39, wherein each three-dimensional object is associable to a material and/or one or more textures.

48. Method according to claim 39, wherein the three-dimensional objects are selected from:
objects read from a file, without intrinsic animation;
objects read from a file, with static intrinsic animation that is contained in the file itself;
objects created in real time.

49. Method according to claim 48, wherein the objects without animation are movable and deformable in real time by the processing unit.

50. Method according to claim 39, wherein an interactive animation is given by the combination of events:
movement of at least a portion of an object without intrinsic animation from an initial position to a final position;
concurrent start of a static animation,
upon the arrival to the final position, pick up of the object by the static animation, which manages it till the end thereof,
return of the object to the initial position.

51. Method according to claim 39, wherein the three-dimensional objects are composite objects with hierarchic structure comprising at least one “father” node that branches off in a recursive manner in at least one “child” sub-node, so that the sub-nodes are movable relative to their ‘father node’ and so that moving the set of father nodes the complete object moves as a single stiff body.

52. Method according to claim 39, wherein the game sheet comprises at least one first level sub-node consisting of a game grid, second level nodes branch off from each first level node that correspond to game frames, third level nodes branch off from each second level node that correspond to the ten throws and to the total score.

53. Method according to claim 51, wherein the position of the sub-nodes relative to their nodes is defined by transformation matrices so that for calculating the absolute position of a part of a composite object (a node), all the transformation matrices are applied in a succession starting from the node itself up to arrive to the base or root.

54. Method according to claim 44, wherein the 3D graphical engine carries out in a sequence the following operations:
clearing a hidden image plane;
starting the lights;
selecting a left camera;
scanning and rendering all the 3D objects present according to the camera view and the lights active on the hidden plane;
selecting an optional second camera;
scanning and rendering all the 3D objects present according to the view of said second camera and the lights active on the hidden plane;
actually presenting the end results on at least one monitor by displaying the hidden plane.

55. System of representation of the bowling game score, comprising detecting means for detecting an external event associated to a game step, a processing unit operatively connected with said detecting means and provided with at least a high performance graphical card capable of piloting at least a monitor, and a graphical engine associated to said graphical card, wherein said processing unit is programmed for acquiring an information related to said external event and representing on said monitor the game score according to the method of representation of the bowling game score as claimed in claim 39.

56. System according to claim 55, wherein the detecting means comprise a detecting device suitable for detecting the ninepin status after a throw and a pinsetter interface suitable for receiving the information from the detecting device and sending it to the processing unit.
